(19) United States
(12) Patent Application Publication
(10) Pub. No.: US 2017/0292325 A1
(43) Pub. Date: Oct. 12, 2017

(54) BARRIER GATE PRESSURE FIT EXTENSION MECHANISM

(71) Applicant: Munchkin, Inc., Van Nuys, CA (US)

(72) Inventors: Quinn Michael Biesinger, Los Angeles, CA (US); Thomas E. Birkert, West Hills, CA (US); Ruth Hsin-Ju Fang, Monterey Park, CA (US)

(21) Appl. No.: 15/484,086

(22) Filed: Apr. 10, 2017

Related U.S. Application Data
(60) Provisional application No. 62/287,387, filed on Apr. 8, 2016.

(51) Int. Cl. E06B 11/02; E06B 9/00; E05B 65/00; E06B 1/52

(52) U.S. Cl. CPC E06B 11/022; E06B 1/52; E06B 9/00; E05B 65/0007; E06B 2009/002

(57) ABSTRACT

A barrier assembly is disclosed having a middle door portion that pivots about a vertical axis on one side of the frame. A linear extending actuator provides widening ability to the barrier assembly, and allows a more secure grip on opposing walls.

### CROSS REFERENCE TO RELATED APPLICATIONS

This application claims priority to U.S. Provisional Patent Application Serial No. 62/287,387, filed Apr. 8, 2016; the content of which is hereby incorporated by reference herein in its entirety into this disclosure.

### TECHNICAL FIELD

The subject disclosure relates generally to barrier assemblies. In particular, the subject disclosure relates to linear actuator extensions for barrier assemblies.

### BACKGROUND

Falls are a leading cause of injuries to children and toddlers in the home. Safety gates can be used around the home to prevent children from entry into a staircase region or keep the children in a safe area in the home where they can be watched by a caregiver. Additionally, safety gates can be used to prevent movement of small household pets into unwanted spaces or rooms. Securing the safety gates poses many challenges, including ease of installation and connection strength. Accordingly, there is a need for the development of a safety gate that can easily be installed and removed and provides a secure installation.

### SUMMARY OF THE SUBJECT DISCLOSURE

The present subject disclosure provides a barrier gate that is easy to assemble and disassemble, has modular component parts, and may be tightened with ease.

In one exemplary embodiment, the present subject matter is a barrier assembly. The barrier assembly includes a frame; a barrier door disposed within the frame; and at least one linear actuator extension disposed inside the frame at about at least one corner of the barrier door, wherein an inwardly force is applied toward the barrier door by the linear actuator extension.

In another exemplary embodiment, the present subject matter is a barrier assembly. The barrier assembly includes a frame; a pivoting barrier door disposed within the frame; a lock assembly having a locking element that releases the frame from the pivoting door when the locking element is engaged; and at least one linear actuator extension disposed inside the frame at about at least one corner of the barrier door, wherein an inwardly force is applied toward the barrier door by the linear actuator extension.

In yet another exemplary embodiment, the present subject matter is a barrier assembly. The barrier assembly includes a frame; a pivoting barrier door disposed within the frame; a lock assembly having a locking element that releases the frame from the pivoting door when the locking element is engaged; and at least one linear actuator extension disposed inside the frame at about at least one corner of the barrier door, wherein an inwardly force is applied toward the barrier door by the linear actuator extension; and wherein the linear actuator extension is adapted to separate the frame and the door when activated.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 illustrates a barrier assembly having a linear actuator extension attached therein, according to an exemplary embodiment of the present subject disclosure.

FIG. 2A illustrates a partial cross sectional view of a linear actuator extension in a retracted position, according to an exemplary embodiment of the present subject disclosure.

FIG. 2B illustrates a partial cross sectional view of a linear actuator extension in a partial extended position, according to an exemplary embodiment of the present subject disclosure.

FIG. 2C illustrates a partial cross sectional view of a linear actuator extension in an extended position, according to an exemplary embodiment of the present subject disclosure.

FIGS. 3A-3F illustrate an assembly procedure for a linear actuator extension, according to an exemplary embodiment of the present subject disclosure.

### DETAILED DESCRIPTION

The subject disclosure is described with reference to the drawings, wherein like reference numerals are used to refer to like elements throughout. In the following description, for purposes of explanation, numerous specific details are set forth in order to provide a thorough understanding of the present disclosure. It may be evident, however, that the present disclosure may be practiced without these specific details.

Particular embodiments of the present subject disclosure will now be described in greater detail with reference to the figures.

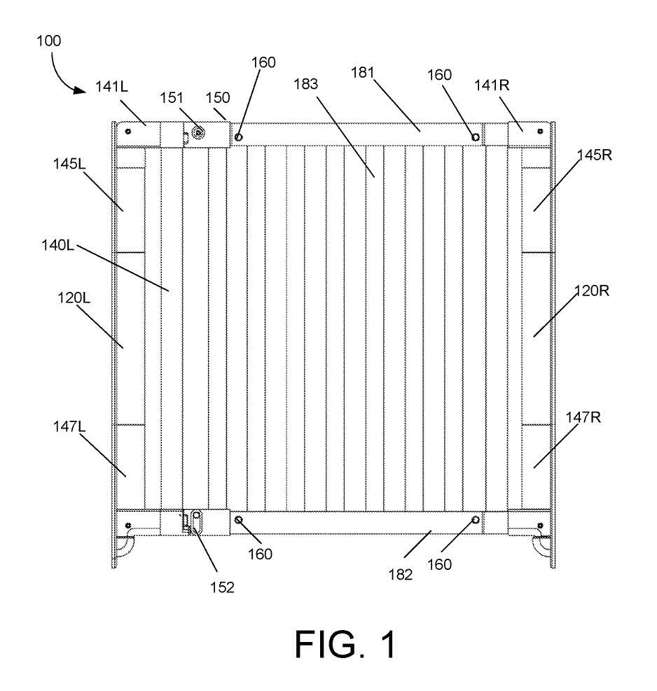

FIG. 1 illustrates a barrier gate assembly 100 having a modular and versatile component system. The left and right sides of the barrier gate have substantially the same or similar components, and so the number labels will be the same. To further differentiate between the left and right sides, “L” is used to designate the left side and “R” is used to designate the right side. In general, a combination of three vertical components 145/120/147 is stacked upon each other on both the left and right sides, as will be discussed in more detail below. Together they form the outer frame or the two “bookend” portions of the barrier gate.

The 145/120/147 combination on each side of the barrier gate 100 is designed to abut against a wall or other flat or study surface and attach the barrier gate 100 thereto. The central portion of the barrier gate comprises a rotatable junction about the 145R/120R/147R vertical axis which allows the central door portion 181/182/183 to pivot to open and close the door portion. Further, one or more clasps or other securing mechanisms 151, 152, 160 etc., may be used to lock the door portion to the left side of the barrier gate frame.

In certain exemplary embodiments, the barrier assembly 100 includes a frame that is to be mounted against opposing walls. A pivoting barrier door is disposed within the frame. Various linear actuator extensions are provided in the frame at about the corners of the barrier door. Further, the present subject disclosure presents an adjustable extender portion 150 which acts to extend the width area of the barrier gate 100 by providing an extendable width gate auxiliary. The extender portion 150 may be adjusted to different widths which would accommodate different needs to extend the side frame to frame width of the barrier gate 100.

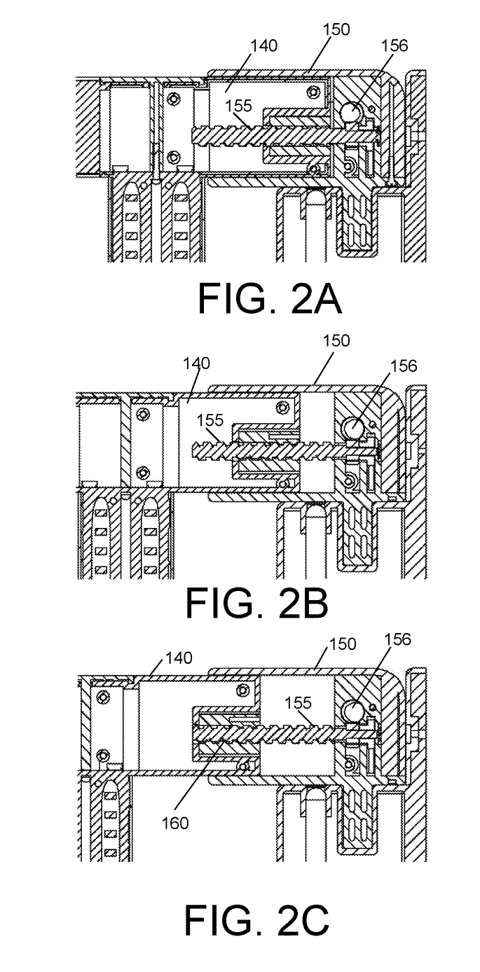

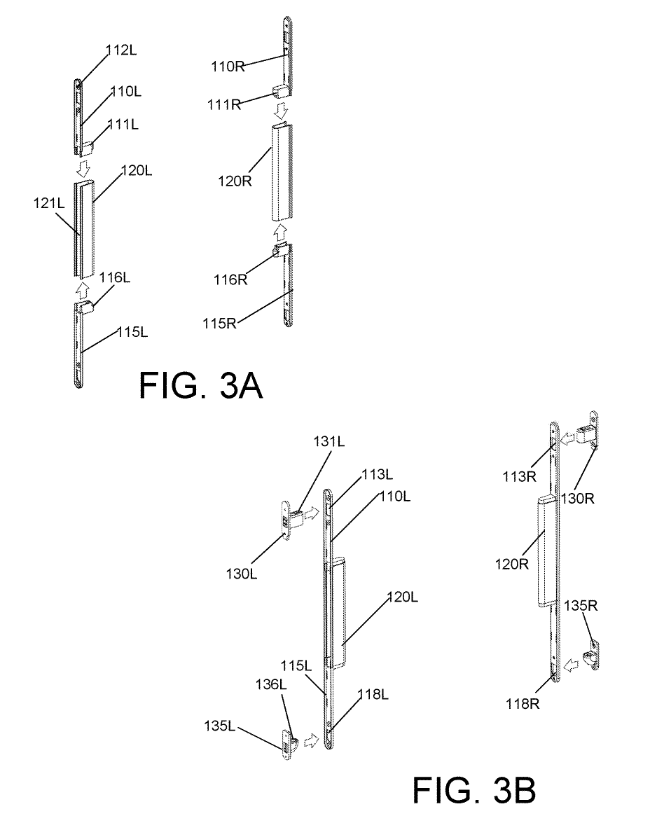

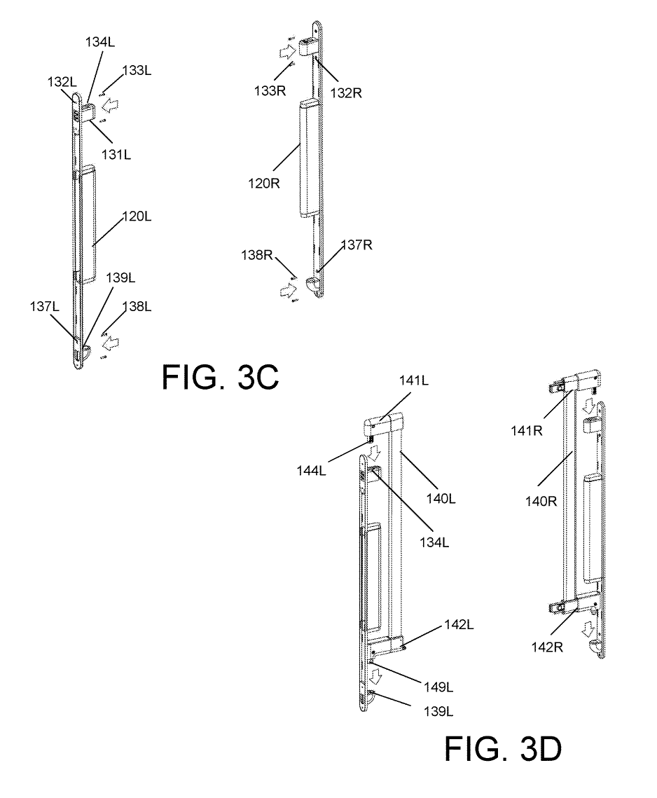

FIGS. 2A-2C illustrate the function of the width extender mechanism in the adjustable extender portion 150. As shown in FIGS. 2A-2C, a linear actuator extension may be positioned in various positions. In FIG. 2A, the linear actuator extension is in a retracted position. That is, the linear actuator extension is secured to a first vertical frame member 140. A male threaded element 155 of the linear actuator extension is adapted to be rotated via a worm gear mechanism causing a female receiving element 160 attached to an intermediate vertical member 140L to retract and extend inward and outward respectively. A screwdriver actuator 156 may be used to drive the worm gear and extend or retract the male threaded element 155 with respect to the female receiving element 160.

As shown in FIG. 2A, the female receiving element 160 is attached to an intermediate vertical member in a retracted position with respect to the length of the male threaded element 155. In FIG. 2B, the female receiving element 160 is attached to the intermediate vertical member is in a partially extended position along the male threaded element 155 thereby exerting a pressure between the frame and the barrier door.

In FIG. 2C, the female receiving element 160 is attached to the intermediate vertical member is in a fully extended position along the male threaded element 155 thereby extending the position between the frame and the barrier door and exerting a sufficient pressure between the frame and the barrier door to secure the barrier assembly in position.

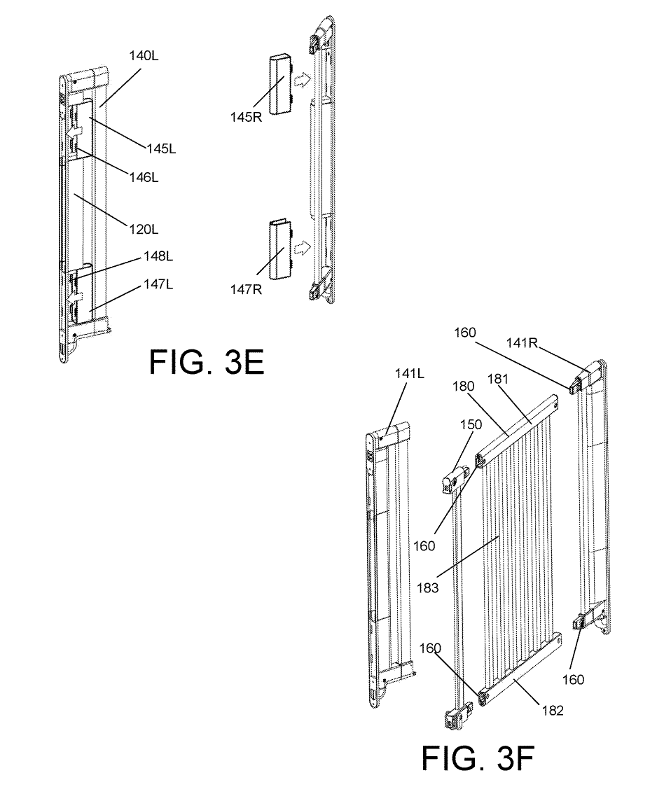

FIGS. 3A-3F illustrate a step by step instruction on how to assemble a barrier gate, according to an exemplary embodiment of the present subject disclosure. The reverse steps may be followed in order to disassemble the barrier gate assembly 100.

In FIG. 3A, an upper vertical component 110 and a lower vertical component 115 are shown to vertically connect to a middle portion 120. Each of the vertical components 110, 115, has a slider 111, 116, respectively, which is designed to slide into and secure within a crevice of the middle portion 120. As shown in FIG. 3B, once the two vertical components 110/115 are secured to middle portion 120, a set of wall securing plates 130, 135 are mounted thereto by inserting a projection 131/136 within corresponding apertures 113/115 in the upper and lower vertical components 110/115, respectively. As illustrated in FIG. 3C, wall securing plates 130/135, are mounted to a wall by screws 133/138, which secure screw holes 132, 137 of the securing plate 130, 135 into opposing walls, respectively.

As illustrated in FIG. 3D, once the opposing sides (or frames) of the barrier gate have been secured to opposing walls, a side frame 140 is mounted on each side. Side frame 140 includes a top portion 141, a bottom portion 142, and downward projections 144, 149, which are adapted to fit within accommodating apertures 134, 139 of the wall securing plates 130, 135, respectively. Next, as shown in FIG. 3E, a set of clasps 145, 147 secure to the areas 146, 148 which serves to lock the side frame 140 into position and prevent its removal.

Finally, FIG. 3F shows door portion 180 having upper horizontal bar 181 and lower horizontal bar 182 securing a plurality of vertical bars 183. Also shown is extender 150 houses the linear actuator described in FIG. 2 in its top portion, and which serves several functions. Once function is to extend the side to side width of the barrier gate assembly 100. Another function is to firmly secure the door portion 180 to the side frames 140 so as to provide a firm, solid and unshakeable barrier.

FIG. 3F also shows a snap lock assembly 160 in various positions. There may be a plurality of snap lock assemblies 160 in the barrier assembly 100. A first snap lock assembly may be located on an upper portion of the frame and a second lock assembly may be located on a lower portion of the frame, as shown in FIG. 3F. It is to be understood that various types of locking mechanisms assemblies are possible in addition to a snap lock assembly.

As shown in FIG. 1, the snap lock assembly 160 is in a closed position. As shown in FIGS. 1 and 3E, a turnbuckle housing may cover a linear actuator extension located on the first vertical frame member. The turnbuckle housing is connected to an upper portion of a securing plate that is mounted to a wall or doorframe.

In FIG. 3E, the snap lock assembly 160 is in an open position. The snap lock assembly 160 includes a receiving hole that mates with a snap lock button. As shown in FIG. 1, the receiving hole is located in the door portion 180. The snap lock button is located on an extension attached to the vertical frame member.

When the snap lock button is depressed, a depressible element attached to the snap lock button releases the extension from a telescoping slot attached to the intermediate vertical member. In the closed position, the extension slides inside the telescoping slot and is locked into position once the snap lock button is placed inside the receiving hole.

The barrier door 180 detaches from the frame after the pivoting barrier door has swung open and the two snap lock assemblies have been configured to the open position as described above.

The illustrations and examples provided herein are for explanatory purposes and are not intended to limit the scope of the appended claims. It will be recognized by those skilled in the art that changes or modifications may be made to the above described embodiment without departing from the broad inventive concepts of the subject disclosure. It is understood therefore that the subject disclosure is not limited to the particular embodiment which is described, but is intended to cover all modifications and changes within the scope and spirit of the subject disclosure.

What is claimed is:

1. A barrier assembly, comprising:
a frame;
a barrier door disposed within the frame; and
at least one linear actuator extension disposed inside the frame at about at least one corner of the barrier door, wherein an inwardly force is applied toward the barrier door by the linear actuator extension.

2. A barrier assembly recited in claim 1, wherein the barrier door pivots along a vertical axis on the frame.

3. A barrier assembly recited in claim 1, wherein the linear actuator has a worm gear mechanism comprising:
a male threaded element; and
a female receiving element attached to an intermediate vertical member, wherein the male threaded element drives into the female receiving element.

4. A barrier assembly recited in claim 3, wherein the worm gear mechanism, in an extended position, causes the female receiving element to extend along the male threaded element, thereby exerting a sufficient pressure between the frame and the barrier door to secure the barrier assembly in position.

5. A barrier assembly recited in claim 1, wherein the frame is modular.

6. A barrier assembly recited in claim 1, further comprising snap lock mechanisms to secure the door portion to the frame.

7. A barrier assembly recited in claim 1, further comprising a clasp to secure the frame to a wall.

8. A barrier assembly, comprising:
a frame;
a pivoting barrier door disposed within the frame; and
a lock assembly having a locking element that releases the frame from the pivoting door when the locking element is engaged.

9. A barrier assembly recited in claim 8, wherein the locking element is a snap lock.

10. A barrier assembly recited in claim 8, wherein the locking assembly has a telescoping slot attached to the pivoting barrier door that receives an extension attached to the frame.

11. A barrier assembly recited in claim 10, wherein the telescoping slot has a receiving hole that mate with the snap lock.

12. A barrier assembly recited in claim 8, wherein the frame is modular.

13. A barrier assembly recited in claim 8, further comprising a clasp to secure the frame to a wall.

14. A barrier assembly, comprising:
a frame;
a pivoting barrier door disposed within the frame;
a lock assembly having a locking element that releases the frame from the pivoting door when the locking element is engaged; and
at least one linear actuator extension disposed inside the frame at about at least one corner of the barrier door, wherein an inwardly force is applied toward the barrier door by the linear actuator extension; and wherein the linear actuator extension is adapted to separate the frame and the door when activated.

15. A barrier assembly recited in claim 14, wherein a second lock assembly is attached to the frame opposite the lock assembly, the second lock assembly having a second snap lock that releases the frame from the pivoting door when the second snap lock is engaged.

16. A barrier assembly recited in claim 14, wherein a second linear actuator extension is attached to the frame opposite the one linear actuator, the second linear actuator extension exerting an inwardly force between the frame and the barrier door.

17. A barrier assembly recited in claim 14, wherein the frame is modular.

18. A barrier assembly recited in claim 14, further comprising snap lock mechanisms to secure the door portion to the frame.

19. A barrier assembly recited in claim 14, further comprising a clasp to secure the frame to a wall.

20. A barrier assembly recited in claim 14, further comprising a worm gear to operate the linear actuator extension.
